(19) United States
(12) Patent Application Publication
(10) Pub. No.: US 2011/0065337 A1
(43) Pub. Date: Mar. 17, 2011

(54) Contact pin socket

(76) Inventor: Sheng-Hsiung Cheng, Yonghe City (TW)

(21) Appl. No.: 12/073,797

(22) Filed: Mar. 10, 2008

(51) Int. Cl. H01R 13/11

(52) U.S. Cl. 439/842

(57) ABSTRACT

A contact pin socket that is installed within a plug socket, and which is able to form an electrical connection with a contact pin set of a plug, wherein two sides of a bottom portion respectively form upwardly extending first folded plates, and top ends of the two sides are respectively inwardly bent and extend towards the inner sides of the first folded plates to form second folded plates. Accordingly, elasticity and deformation amount of the first folded plates and the second folded plates are used to disperse the applied force produced when contact pins are inserted, moreover, elastic softness of the contact pin socket is increased when subjected to an applied force, thereby effectively reducing elastic metal fatigue of the contact pin socket.

### BACKGROUND OF THE INVENTION

(a) Field of the Invention

The present invention relates to a contact pin socket that is installed within a plug socket, and which is able to disperse the applied force produced when contact pins are inserted, thereby increasing elastic softness of the contact pin socket and reducing the possibility of permanent deformation of the contact pin socket.

(b) Description of the Prior Art

Referring to FIG. 1, which shows a cutaway view of a contact pin socket of the prior art, which primarily comprises a contact pin socket 10 provided with a slightly U-shaped cross-sectional form, and a slot 102 is formed at the center of the contact pin socket 10. Inwardly protruding circular arc-shaped contact portions 101 are formed at centers of the two sides of the slot 102 of the contact pin socket 10, and the protruding contact portions 101 are provided with the effectiveness to grip a contact pin 20, thereby enabling a tighter electrical connection between the contact pin socket 10 and the contact pin 20.

However, after inserting the contact pin 20 into the contact pin socket 10, then the contact portions 101 are subjected to insertion compression, producing elastic deformation which causes the contact pin 20 to produce a lateral force F on the contact portions 101 of the contact pin socket 10, whereby the lateral force F exerts a pushing force exactly on the sides of the contact pin socket 10, which further produces a moment diverging push with the bottom portion acting as a fulcrum. Hence, after a contact pin has been inserted and extracted an excessive number of times or a contact pin has been left inserted for a comparatively long period of time, then, elastic fatigue causes the contact pin socket 10 manufactured from metal material to spread outward, thereby causing the slot 102 to gradually widen. Accordingly, electrical contact is degraded, resulting in a short circuit or poor electrical contact, and hence there is a need for improvement.

### SUMMARY OF THE INVENTION

In light of the shortcomings of the aforementioned prior art structure, the inventor of the present invention, having accumulated years of experience in related arts, has meticulously carried out extensive study and exploration to ultimately design a new improved contact pin socket. And a primary objective of the present invention is to provide a contact pin socket which is able to reduce metal fatigue and increase elastic softness.

In order to achieve the aforementioned objective, two sides of a bottom portion of the contact pin socket of the present invention are respectively formed with first folded plates and second folded plates, and first bent portions are respectively formed between the first folded plates and the second folded plates. Accordingly, the first folded plates and the second folded plates respectively formed on the two sides of the contact pin socket are able to disperse the applied force produced when a contact pin is inserted into the contact pin socket and firmly grip the contact pin, as well as reducing metal fatigue and prolonging operational life of the contact pin socket.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a cutaway view of a contact pin socket of the prior art.

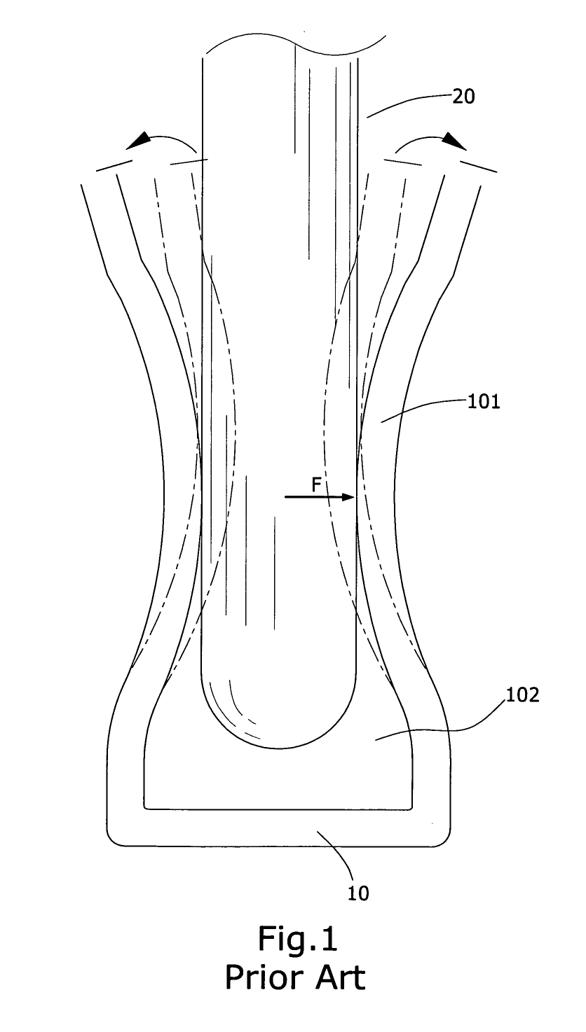

FIG. 2 shows a structural schematic view of a preferred embodiment according to the present invention.

FIG. 3 shows a cutaway view (1) depicting implementation of the preferred embodiment according to the present invention.

FIG. 4 shows a cutaway view (2) depicting implementation of the preferred embodiment according to the present invention.

FIG. 5 shows a structural elevational view of another preferred embodiment according to the present invention.

FIG. 6 shows a schematic view (1) depicting the preferred embodiment in use according to the present invention.

FIG. 7 shows a schematic view (2) depicting the preferred embodiment in use according to the present invention.

FIG. 8 shows a side view of yet another preferred embodiment according to the present invention.

### DETAILED DESCRIPTION OF THE PREFERRED EMBODIMENTS

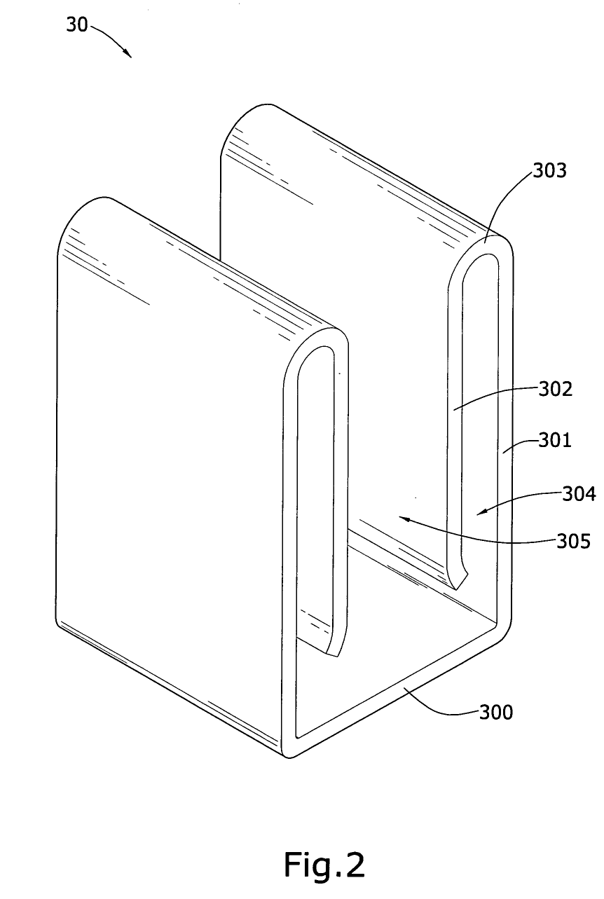

Referring to FIG. 2, which shows a structural schematic view of a preferred embodiment according to the present invention, wherein a contact pin socket 30 is a metallic bent member, which primarily comprises a bottom plate 300, two sides of which are respectively upwardly bent to form first folded plates 301, and ends of the first folded plates 301 respectively form bent portions 303 which are respectively inwardly bent towards the inner sides of the first folded plates 301 to form second folded plates 302. The first folded plates 301 and the second folded plates 302 are approximately parallel, and gaps 304 are respectively formed between the first folded plates 301 and the second folded plates 302; moreover, a slot 305 is formed between the two second folded plates 302.

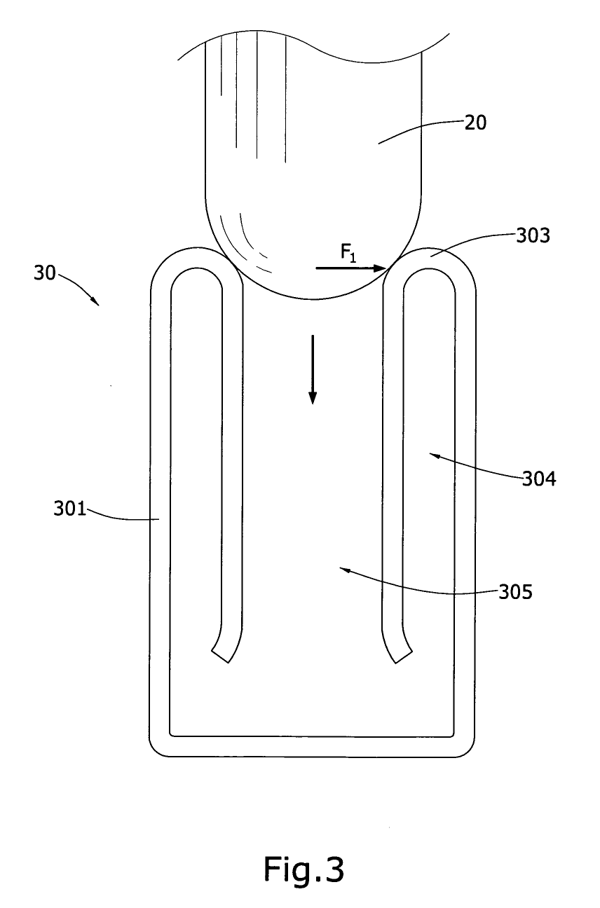

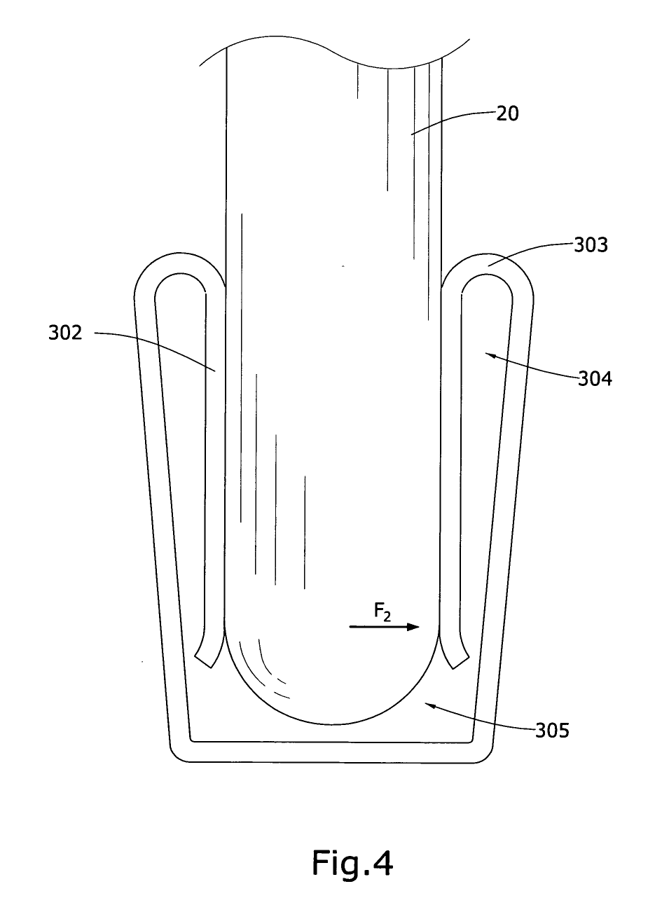

Referring to FIG. 3 and FIG. 4, which show cutaway views (1), (2) respectively depicting implementations according the preferred embodiment, and as depicted in FIG. 3, when a contact pin 20 is inserted into the contact pin socket 30, then the contact pin 20 first contacts a portion of an upper section of the slot 305, after which, referring to FIG. 4, the first folded plates 301 outwardly expand using the bottom portion as a fulcrum to increase elasticity and absorb a resistance force F1. When the contact pin 20 is further inserted into the interior of the slot 305, then the contact area between the contact pin 20 and the second folded plates 302 becomes greater, thereby causing the second folded plates 302 to deviate slightly from the bent portions 303 towards the inner sides of the gaps 304, and enabling a lateral force F2 produced by the contact pin 20 to be absorbed by the second folded plates 302. Because the contact pin socket 30 is mainly manufactured from copper material of good electric conductivity, in addition to the increased elasticity provided by the structural design of the present invention, thus, a force F exerted on the contact pin socket 30 by the contact pin 20 is effectively dispersed and absorbed, thereby reducing elastic fatigue.

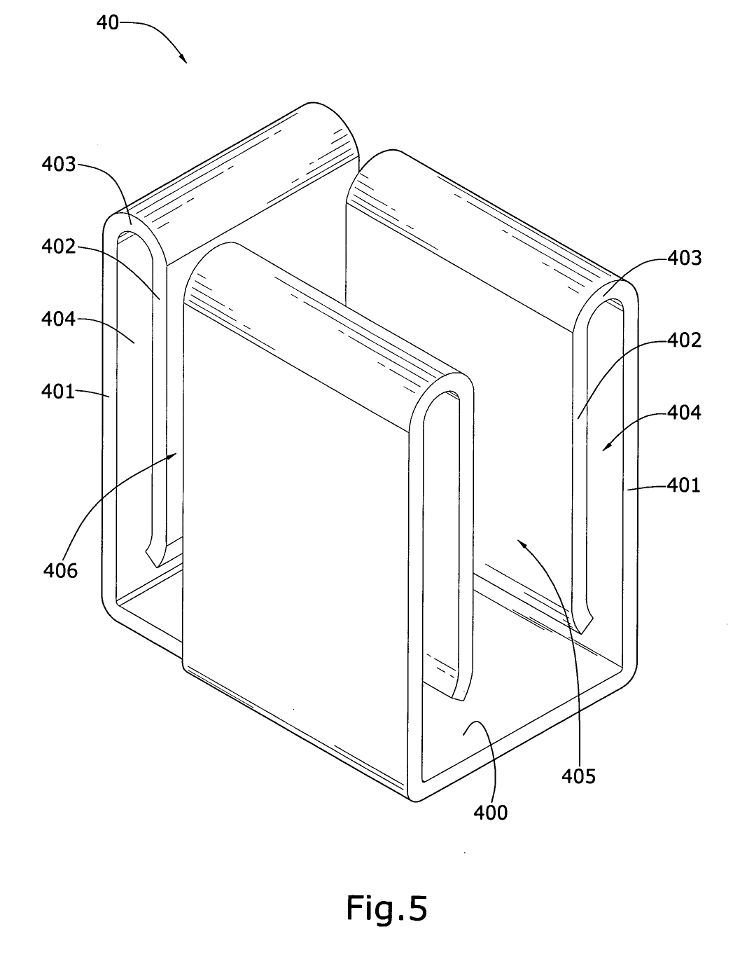

Referring to FIG. 5, which shows an elevational structural view of another preferred embodiment according to the present invention, wherein the embodiment primarily comprises a rectangular bottom plate 400, three sides of which are respectively upwardly bent to form first folded plates 401. Moreover, ends of the first folded plates 401 respectively form bent portions 403 which are respectively inwardly bent towards the inner sides of the first folded plates 401 to form second folded plates 402. The first folded plates 401 and the second folded plates 402 are approximately parallel, and gaps 404 are respectively formed between the first folded plates 401 and the second folded plates 402. Furthermore, a slot 405 is formed between the two oppositely disposed second folded plates 402, and another gap 406 is formed between the other second folded plate 402 and the two oppositely disposed second folded plates 402.

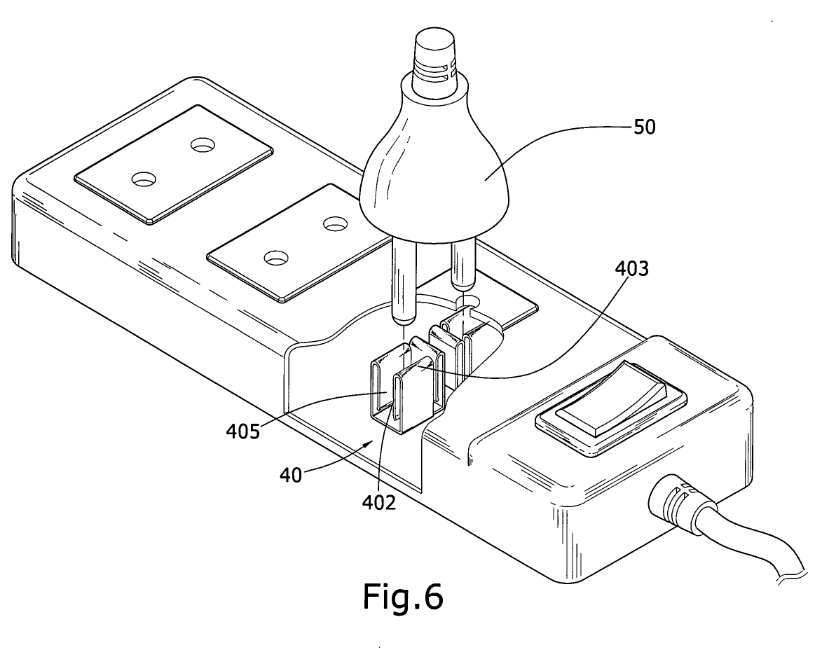

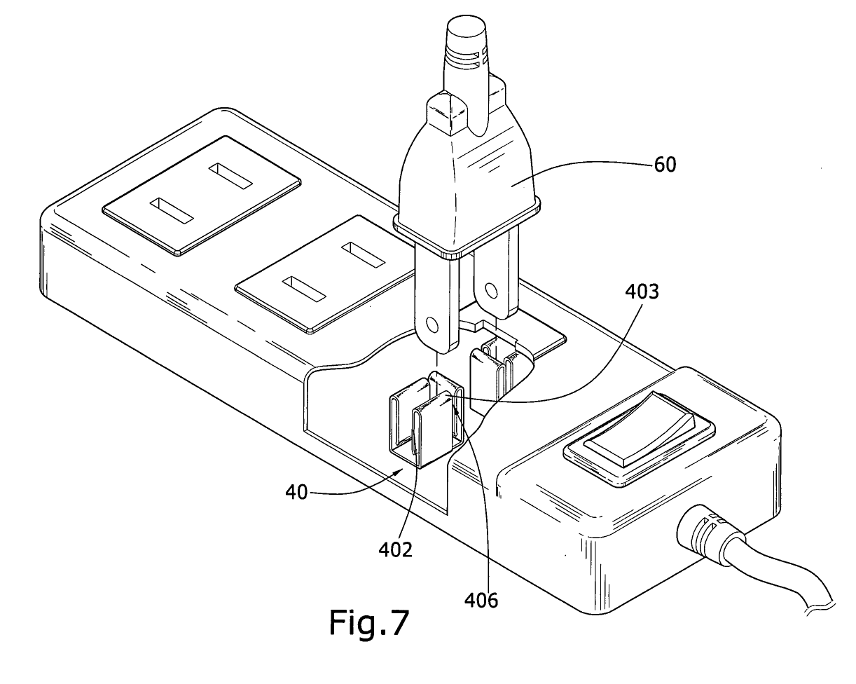

The structural system as depicted in FIG. 5 is an embodiment which can be used by two different plug contacts. Referring to FIG. 6, which shows a plug terminal with circular contact pins 50 being respectively inserted into the slots 405 of the two opposite facing folded plates 402 of the contact pin sockets 40 of the present invention to form a stable electrical contact therebetween. Moreover, referring to FIG. 7, which shows a plug terminal with flat contact pins 60 being respectively inserted into the contact pin sockets 40, in which the flat contact pins 60 are respectively inserted into the gaps 406 between the three second folded plates 402 arranged in a U-shaped configuration of each of the contact pin sockets 40, thereby similarly forming a stable electrical contact therebetween. Accordingly, the design of the present invention is not only applicable for use by plugs provided with the circular contact pins 50, but can also be used by plugs provided with the flat contact pins 60, thus providing widespread use of the present invention.

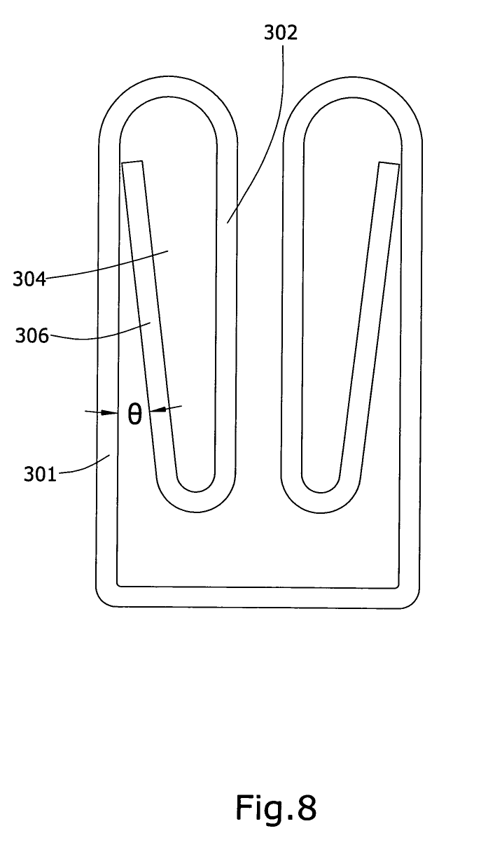

Referring to FIG. 8, which shows an embodiment depicting a further variation and improvement, wherein ends of the second folded plates 302 of the contact pin socket 30 are respectively further internally bent to form third folded plates 306. The third folded plates 306 respectively extend into the gaps 304, and each end slightly contacts the first folded plates 301, thus causing an included angle φ to be formed with the first folded plates 301, which provide increased and improved elasticity. Furthermore, the design providing the included angles φ respectively between the third folded plates 306 and the first folded plates 301 enables the upper portion of the second folded plates 302 to be subjected to a substantially tight diverging force while providing better elasticity at the lower portion, thereby achieving the effectiveness to enable firmer retention of a contact pin, and thus preventing the contact pin from easily coming away.

As a result of the attentive design of the present invention, the present invention is provided with the following advantages when in use:

1. The present invention is characterized in that it is formed from the first folded plates 301 and the second folded plates 302 to enable absorbing a force exerted thereon and prevent elastic fatigue; as well as providing better restoring elasticity, thereby preventing permanent deformation and providing the contact pin socket of the present invention with consistency in the puling and inserting forces.

2. The present invention is further characterized in that it comprises a structural configuration which uses the bottom plate 300 as a base, and three sides of the bottom plate 300 are respectively formed with the aforementioned first folded plates 301 and the second folded plates 302 to assume a U-shaped structural arrangement when seen from above, thereby providing a structural configuration which can be used by circular contact pin plugs and flat contact pin plugs for the more convenient use thereof.

3. The design of the present invention is yet further characterized in that it is further formed with the third folded plates 306, which are respectively bent to form an included angle with the first folded plates 301, thereby providing the upper portion of the second folded plates 302 with a substantially tight diverging force, and providing the lower portion with better elasticity, and thus providing the entire structural configuration with the effectiveness to enable firmer retention of a contact pin to prevent the contact pin from easily coming away.

In conclusion, the effectiveness of the contact pin socket of the present invention to provide industrial practicability complies with the essential elements as required for a new patent application, accordingly a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A contact pin socket, comprising a bottom plate, two sides of the bottom plate are respectively upwardly bent to form first folded plates, and ends of the first folded plates respectively form bent portions which are respectively inwardly bent towards the inner sides of the first folded plates to form second folded plates, moreover, gaps are respectively formed between the first folded plates and the second folded plates; and a slot is formed between the two second folded plates.

2. The contact pin socket according to claim 1, wherein the first folded plates are parallel with the second folded plates.

3. The contact pin socket according to claim 1, wherein ends of the second folded plates are respectively further internally and upwardly bent to form third folded plates, and the third folded plates respectively extend into the gaps.

4. The contact pin socket according to claim 1, wherein ends of the third folded plates respectively slightly contact the first folded plates to form an included angle therewith.

5. A contact pin socket, comprising a bottom plate, three sides of the bottom plate are respectively upwardly bent to form first folded plates, and ends of the first folded plates respectively form bent portions which are respectively inwardly bent towards the inner sides of the first folded plates to form second folded plates, the first folded plates and the second folded plates are approximately parallel, and gaps are respectively formed between the first folded plates and the second folded plates, moreover, a slot is formed between the two oppositely disposed second folded plates, and another gap is formed between the other second folded plate and the two oppositely disposed second folded plates.

6. The contact pin socket according to claim 5, wherein the first folded plates are parallel with the second folded plates.

7. The contact pin socket according to claim 5, wherein ends of the second folded plates are respectively further internally and upwardly bent to form third folded plates, and the third folded plates respectively extend into the gaps.

8. The contact pin socket according to claim 5, wherein ends of the third folded plates respectively slightly contact the first folded plates to form an included angle therewith.
